(19) United States
(12) Patent Application Publication
(10) Pub. No.: US 2020/0314953 A1
(43) Pub. Date: Oct. 1, 2020

(54) METHODS AND APPARATUS FOR MANAGING SIDELINK TRAFFIC PRIORITIZATION

(71) Applicant: MEDIATEK INC., Hsinchu (TW)

(72) Inventor: Guan-Yu LIN, Hsinchu City (TW)

(73) Assignee: MEDIATEK INC., Hsinchu (TW)

(21) Appl. No.: 16/831,304

(22) Filed: Mar. 26, 2020

Related U.S. Application Data
(60) Provisional application No. 62/825,091, filed on Mar. 28, 2019.

(51) Int. Cl. H04W 80/02; H04W 72/10; H04W 28/02; H04W 72/14

(52) U.S. Cl. CPC H04W 80/02; H04W 72/10; H04W 92/18; H04W 72/14; H04W 28/0278

(57) ABSTRACT

Aspects of the disclosure provide methods and apparatuses for managing traffic prioritization among sidelink logical channels. In an embodiment, an apparatus can be configured to associate sidelink logical channels with priorities and sidelink cast types at a UE and to determine a first sidelink logical channel having a highest priority of the sidelink logical channels according to the priorities of the sidelink logical channels. The apparatus can be further configured to generate a medium access control (MAC) protocol data unit (PDU), wherein data of a subset of the sidelink logical channels that has a same sidelink cast type as the first sidelink logical channel are multiplexed into the MAC PDU.

### INCORPORATION BY REFERENCE

This present disclosure claims the benefit of U.S. Provisional Application No. 62/825,091, “Method to support traffic prioritization in sidelink traffic transmission” filed on Mar. 28, 2019, which is incorporated herein by reference in its entirety.

### TECHNICAL FIELD

The present disclosure relates to wireless communications, and, more particularly, to methods and apparatus to manage sidelink traffic prioritization.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Vehicular communication or vehicle-to-everything (V2X) communication can have various sidelink communication cast types, such as unicast (one-to-one) type, groupcast (one-to-many) type, broadcast (one-to-all) type and the like, and support different sidelink resource scheduling modes.

### SUMMARY

Aspects of the disclosure provide a method for managing sidelink traffic prioritization among sidelink logical channels that are associated with different priorities and different sidelink cast types. In an embodiment, the method can include associating sidelink logical channels with priorities and sidelink cast types at a user equipment (UE). In another embodiment, the method can further include determining a first sidelink logical channel having a highest priority of the sidelink logical channels according to the priorities of the sidelink logical channels. In some other embodiments, the method can also include generating a medium access control (MAC) protocol data unit (PDU), wherein data of a subset of the sidelink logical channels that has a same sidelink cast type as the first sidelink logical channel are multiplexed into the MAC PDU. The sidelink cast types can include a unicast type, a groupcast type, and a broadcast type.

In various embodiments, the subset of the sidelink logic channels has the unicast type, and the data of the subset of the sidelink logic channels have a same destination ID. In some other embodiments, the subset of the sidelink logic channels has the groupcast type, and the data of the subset of the sidelink logic channels have a same destination group ID.

Aspects of the disclosure can further provide an apparatus for managing sidelink traffic prioritization among sidelink logical channels that are associated with different priorities and different sidelink cast types. In an embodiment, the apparatus includes processing circuitry and generating circuitry. The processing circuitry can associate sidelink logical channels with priorities and sidelink cast types, and determine a first sidelink logical channel having a highest priority of the sidelink logical channels according to the priorities of the sidelink logical channels. In some other embodiments, the generating circuitry can generate a MAC PDU, wherein data of a subset of the sidelink logical channels that has a same sidelink cast type as the first sidelink logical channel are multiplexed into the MAC PDU.

Aspects of the disclosure can also provide another method for managing sidelink traffic prioritization among sidelink logical channels that are associated with different sidelink resource scheduling modes. The method can include associating a first subset of sidelink logical channels with a first sidelink resource scheduling mode and associating a second subset of the sidelink logical channels with a second sidelink resource scheduling mode. The method can further include determining a sidelink resource grant associated with the first sidelink resource scheduling mode or the second sidelink resource scheduling mode. In yet another embodiment, the method can further include transmitting data of the first subset of the sidelink logical channels that is associated with the first sidelink resource scheduling mode over the sidelink resource grant when the sidelink resource grant is associated with the first sidelink resource scheduling mode. The method can also include transmitting data of the second subset of the sidelink logical channels that is associated with the second sidelink resource scheduling mode over the sidelink resource grant when the sidelink resource grant is associated with the second sidelink resource scheduling mode.

In an embodiment, the sidelink resource grant can be associated with the first sidelink resource scheduling mode, the data of the first subset of the sidelink logical channels are transmitted over the sidelink resource grant with sidelink resources that are allocated by a base station, and the method can further include transmitting a scheduling request to the base station.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a diagram showing various sidelink communication cast types in NR V2X according to some embodiments of the disclosure;

FIG. 2 is a flow chart of an exemplary method for managing sidelink traffic prioritization among sidelink logical channels according to some embodiments of the disclosure.

FIG. 3 shows a diagram of an exemplary wireless communication system according to some embodiments of the disclosure;

FIG. 4 is a flow chart of another exemplary method for managing traffic prioritization among sidelink logical channels according to some embodiments of the disclosure; and

FIG. 5 is a diagram showing sidelink logical channels that are divided into two groups associated with two different sidelink resource scheduling modes, respectively; and

FIG. 6 is a block diagram of an apparatus for managing sidelink traffic prioritization among sidelink logical channels according to some embodiments.

### DETAILED DESCRIPTION OF EMBODIMENTS

As specified in 3GPP NR standard, a user equipment (UE) can support unicast, groupcast, and broadcast type sidelink communication at the same time. As data packets having different sidelink cast types come from upper layers through different sidelink logical channels, a media access control (MAC) layer of the UE has to decide how to prioritize and multiplex these data packets into MAC protocol data units (PDUs). The sidelink logical channels are associated with different priorities and different sidelink cast types. At least one of the sidelink logical channels that has a highest priority is determined. Further, data of at least one of the logical channels that has the same sidelink cast type as the highest-priority sidelink logical channel are multiplexed into a MAC PDU.

According to 3GPP NR standard, sidelink logical channels can be associated with different sidelink resource scheduling modes. Similarly, as data packets come through different sidelink logical channels from upper layers, the UE has to decide how to prioritize and multiplex these data packets into MAC PDUs. In an embodiment, the sidelink logical channels are associated with different sidelink resource scheduling modes. In another embodiment, a sidelink resource grant is determined to be associated with a specific sidelink resource scheduling mode. In other embodiments, data of at least one of the sidelink logical channels that is associated with the specific sidelink resource scheduling mode are multiplexed into a MAC PDU.

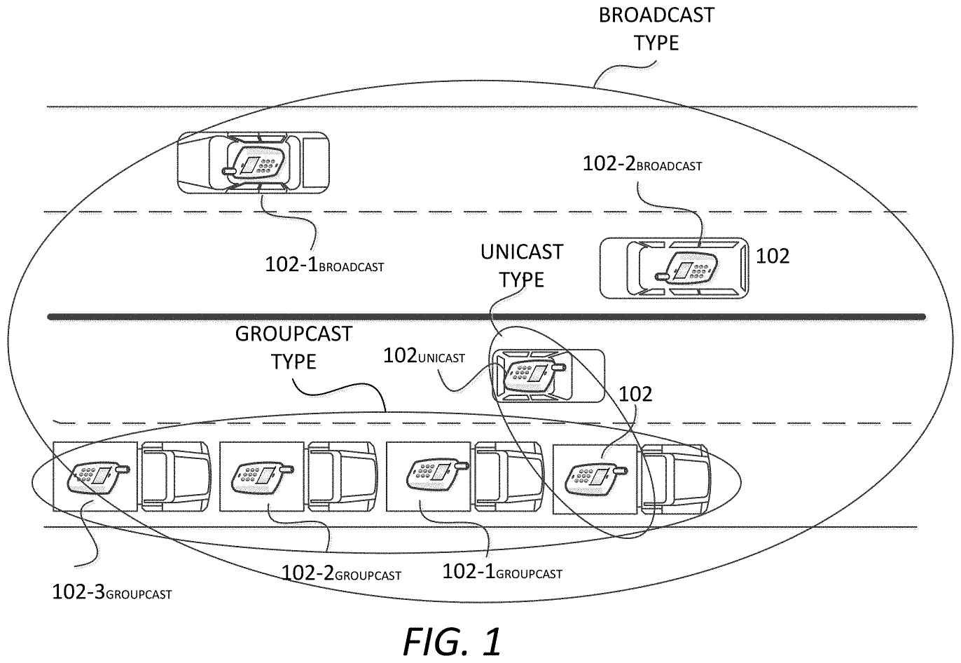

FIG. 1 is a diagram showing various sidelink communication types in NR V2X. As specified in the 3GPP NR standard, a UE can perform sidelink communication in a unicast (one-to-one) type, in a groupcast (one-to-many) type, and in a broadcast (one-to-all) type. In NR V2X unicast communications, a transmitter UE has a single receiver UE. For example, a transmitter UE 102 preforms sidelink communication with a receiver UE ¹⁰²_{UNICAST} in the unicast type. The groupcast type is used when a transmitter UE wishes to communicate with more than one, but only a specific group of UEs in its vicinity. As shown in FIG. 1, the transmitter UE 102 (e.g., a platoon leader) communicates with a specific group of the three UEs, UE 102-1_{GROUPCAST}, UE 102-2_{GROUPCAT}, and UE 102-3_{GROUPCAST} (e.g., platoon members) in the groupcast type. The broadcast type enables a transmitter UE to broadcast periodic messages, for example, to all UEs within its transmission range. For example, the transmitter UE 102 broadcasts periodic messages to UE 102-1_{BROADCAST} and UE 102-2_{BROADCAST}, and UE 102_{UNICAST}, UE 102-1_{GROUPCAST}, UE 102-2_{GROUPCAST} and UE 102-3_{GROUPCAST} as well.

The unicast, groupcast, and broadcast types may be implemented at Layer1/2 or at higher layers. For example, Layer 2 can provide information about source identification (ID) and destination ID for unicast type data packets, and provide source ID and destination Group ID for groupcast type data packets. Any UE configured to receive a Layer 2 destination Group ID is allowed to receive the groupcast transmission. MAC layer multiplexes data packets having the same sidelink cast type into MAC PDUs.

Logical channel prioritization (LCP) procedure is applied when a new transmission is performed, for example when the MAC layer needs to multiplex data packets coming through logical channels and generate PDUs, and is designed to ensure that UEs satisfy the quality of service (QoS) of each configured radio bearer. The simplest multiplexing rule for the MAC layer is to serve the logical channels in strict priority order, and all resources will be given to the highest-priority logical channel until its transmission buffer is empty. However, this may result in starvation of lower-priority logical channels. Typically, an operator would instead like to provide at least some throughput for low-priority services as well. Therefore, a prioritized bit rate (PBR) is configured in addition to the priority value. The logical channels are then served in decreasing priority order up to their prioritized data rate, which avoids starvation as long as the scheduled data rate is at least as large as the sum of the prioritized data rates. Beyond the prioritized bit rates, logical channels are served in strict priority order until the grant is fully exploited or the buffer is empty.

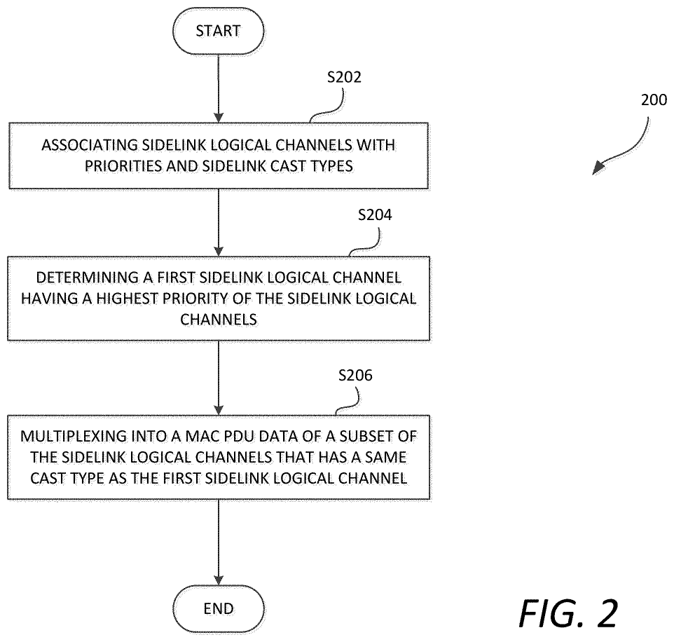

FIG. 2 is a flow chart of an exemplary method 200 for managing sidelink traffic prioritization among sidelink logical channels according to some embodiments of the disclosure. The method 200 can be performed at a UE. When receiving data packets having different sidelink cast types from a variety of sidelink logical channels having different priority values, the MAC layer of a UE has to decide a prioritization of the transmission of these data packets, i.e., how to prioritize and multiplex these data packets into MAC PDUs.

At step S202, the UE 102 associates sidelink logical channels with priorities and sidelink cast types. For example, data are transmitted through six sidelink logical channels LCs 0-5, and the UE 102 can associate the six sidelink logical channels 0-5 with priorities of 4, 0, 1, 2, 5 and 3, respectively, and with sidelink cast types of broadcast, groupcast, unicast, groupcast, unicast and groupcast, respectively.

At step S204, the UE 102 determines a first sidelink logical channel having a highest priority of the sidelink logical channels according to the priorities of the sidelink logical channels. Accordingly, the UE 102 determines the sidelink logical channel 1 of the sidelink logical channels 0-5 to be the first sidelink logical channel, as the sidelink logical channel 1 has the highest priority “0.”

At step S206, the UE 102 generates a MAC PDU, wherein data of a subset of the sidelink logical channels that has the same sidelink cast type as the first sidelink logical channel are multiplexed into the MAC PDU. Accordingly, the UE 102 multiplexes data of the highest-priority sidelink logical channel 1, which has the sidelink groupcast type, and data of the sidelink logical channels 3 and 5, which also have the sidelink groupcast type, into the MAC PDU. Therefore, the data in the MAC PDU have the same sidelink cast type, and contain the data of the sidelink logical channel having the highest priority.

In an embodiment, the data of the subset of the sidelink logic channels that has the same sidelink cast type as the first sidelink logical channel have the same destination ID as the first sidelink logical channel if the sidelink cast type is unicast type and have the same destination group ID as the first sidelink logical channel if the sidelink cast type is groupcast type.

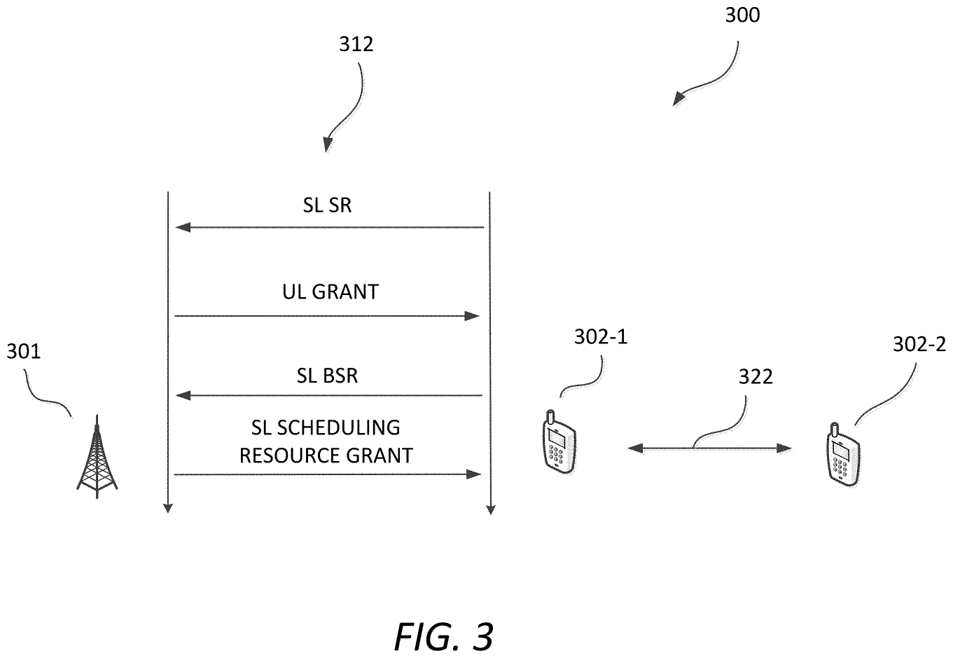

FIG. 3 shows a diagram of an exemplary wireless communication system 300, in view of sidelink resource scheduling modes, specified in 3GPP NR standard according to some embodiments of the disclosure. The wireless communication system 400 can include a base station 301, a first UE 302-1, and a second UE 302-2. As shown, the base station 301 can schedule sidelink resources to the first UE 302-1, as indicated by “312,” and the first UE 302-1 can also select sidelink resources by itself, as indicated by “322.”

The base station 301 can be any device that wirelessly communicates with the UEs 302 via Uu interfaces (not shown). For example, the base station 301 can be an implementation of a gNB specified in the 3GPP New Radio (NR) standard. Alternatively, the base station 301 can be an implementation of an eNB specified in 3GPP Long Term Evolution (LTE) standard. Accordingly, the base station 301 can communicate with, for example, the first UE 302-1 via the uplink/downlink radio interfaces according to respective wireless communication protocols. In yet other embodiments, the base station 301 can implement other types of standardized or non-standardized radio access technologies, and communicate with the UEs 302 according to the respective radio access technologies.

The UEs 302 can be any device that is capable of wirelessly communicating with the base station 301 via the uplink/downlink radio interfaces, as well as communicating with the UEs 302 via the PC5 interfaces (not shown) directly. For example, the UEs 302 can be a vehicle, a computer, a mobile phone, and the like. The PC5 interfaces can be a direct radio link established between the UEs 302. In V2X, the sidelink communication includes vehicle to vehicle (V2V) communication, mobile phone to mobile phone communication, device to device (D2D) communication, and the like.

The UEs 302 configured in the first sidelink scheduling mode, in which sidelink resources are scheduled by the base station 301, cannot transmit sidelink traffic via PC5 interface by selecting sidelink resources on their own. The base station 301 (e.g., using a scheduler) needs the knowledge about the amount and destination UEs of sidelink traffic UEs 302 wants to transmit, so that the UEs 302 can then schedule sidelink resources by themselves accordingly. A scheduling request (SR) is a special physical layer message, and has a simple flag, only a single bit, to keep the uplink overhead small. The UEs 302, if having no valid scheduled sidelink grant, can send a sidelink SR (SL SR) to the base station 301 to ask the base station 301 to send an uplink grant (UL grant) so that the UEs 302 can transmit PUSCH to include the buffer status information for sidelink transmission, i.e., a sidelink buffer status report (BSR). For example, when sidelink data with higher priority than those already existing in the sidelink transmitting buffers arrive at the first UE 302-1 and the first UE 302-1 does not have a sidelink grant and hence cannot transmit the sidelink data, the first UE 302-1 then needs to send the sidelink BSR on a UL grant (PUSCH) to the base station 301 for requesting sidelink resources. If at that time, the first UE 302-1 has a UL grant available for transmitting the sidelink BSR, then the first UE 302-1 generates the sidelink BSR MAC control element and includes it in the UL grant; if the first UE 302-1 has no UL grant available to transmit the sidelink BSR, the first UE 302-1 is then triggered to transmit an SL SR at the next available SL SR resource (i.e., SR occasion) corresponding to the sidelink logical channel which triggers the SL SR transmission. An SR resource of an SL SR configuration is considered available only when the associated SR prohibit timer is not running. Upon reception of the SL SR, the scheduler of the base station 301 can assign a UL grant to the first UE 302-1, so that the first UE 302-1 can include the sidelink BSR into the granted UL grant. The first UE 302-1 sends the SL SR on a PUCCH only when there is not any PUSCH available yet for transmitting the sidelink BSR. If the first UE 302-1 does not receive resources scheduled from the base station 301, it can re-send the SL SR on the PUCCH.

A consequence of the single-bit SL SR is the limited knowledge at the base station 301 about the buffer situation at the first UE 302-1. To be specific, since the SL SR only carries 1-bit information, the base station 301 can only know the priority of the sidelink data the first UE 302-1 has (i.e., based on the priority of sidelink logical channels associated with the SR configuration on which an SL SR transmission is detected), without any knowledge about the amount of the sidelink traffic the first UE 302-1 has in its sidelink transmitting buffer. In response, the base station 301 may assign a small amount of uplink resources for UE to report the amount of its sidelink traffic available for transmission and the associated destination UE, i.e., the sidelink buffer status report (BSR). With the information in the sidelink BSR, the base station 301 can then allocate resources accordingly. Each buffer-size field in a sidelink BSR indicates the amount of data awaiting transmission across all logical channels in a logical channel group (LCG) for a specific destination UE. The first UE 302-1 can send the sidelink BSR (or the sidelink BSR can be triggered) to the base station 301 in three situations: if sidelink data become available for transmission when the sidelink transmitting buffers for a specific destination UE were previously empty; if for a specific destination UE, sidelink data become available for transmission on a logical channel with a higher priority than those that the sidelink transmitting buffers previously store; or if a timer expires while data are waiting for transmission. After transmitting the sidelink BSR, the first UE 302-1 expects the base station 301 to reply with a sidelink scheduling resource grant. After receiving the sidelink BSR, the base station 301 can schedule sidelink resources of an appropriate size to the first UE 302-1.

For sidelink transmission, the first UE 302-1 can be configured with a resource pool, i.e., a set of physical resources, by the following ways: a resource pool can be individually configured via dedicated RRC signaling for devices in RRC CONNECTED state; a common resource pool can be provided by means of the sidelink-specific system information blocks (SIBs); and there may be pre-configured resource pool to be used by out-of-coverage devices. Each resource pool can consist of a PSCCH subframe pool, a PSCCH resource-block pool, a PSSCH subframe pool and a PSSCH resource-block pool.

There are two modes of sidelink communication. They differ in terms of whether a device is assigned or select by itself the exact set of sidelink resources to use for the sidelink transmission from a configured resource pool. In case of sidelink communication mode 1 (or referred to as sidelink resource scheduling mode 1), a device is explicitly assigned, by means of a scheduling resource grant received from the base station 301, a specific set of PSCCH/PSSCH resources. In case of sidelink communication mode 2 (or referred to as sidelink resource scheduling mode 2), a device selects the set of PSCCH/PSSCH resources by itself autonomously. As it relies on explicit scheduling grants assigned by the base station 301, the sidelink resource scheduling mode 1 is only possible for in-coverage devices in RRC_CONNECTED state. Sidelink communication in sidelink resource scheduling mode 2 is possible in coverage as well as out of coverage and in both RRC_IDLE and RRC_CONNECTED states. Only the sidelink resource scheduling mode 1 triggers SL SR and SL BSR mechanisms.

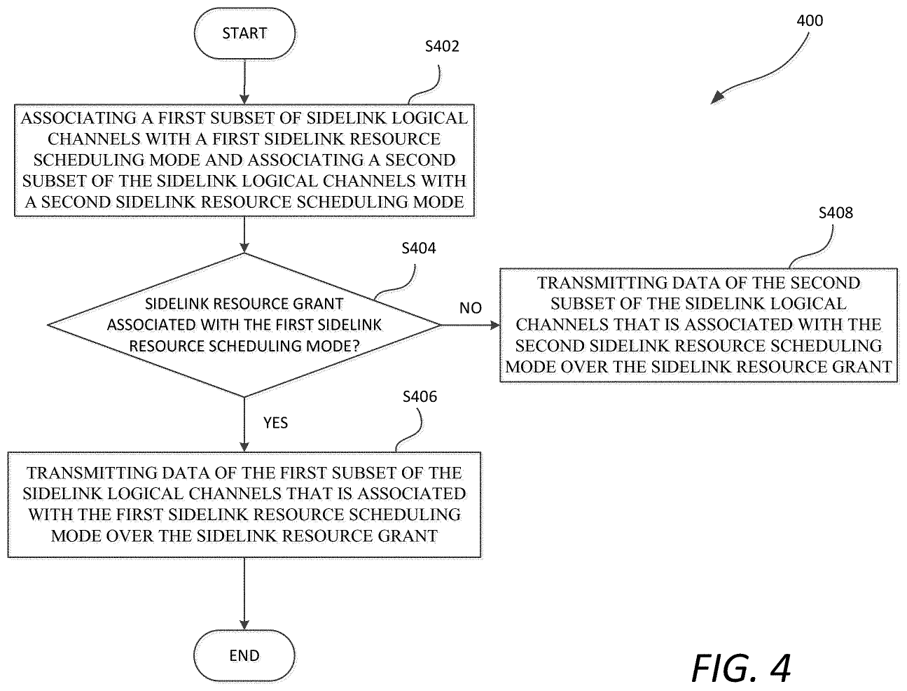

FIG. 4 is a flow chart of another exemplary method 400 for managing traffic prioritization among sidelink logical channels according to some embodiments of the disclosure.

The method 400 can include steps S402 to S408. The method 400 can be performed at the UEs 302.

At step S402, the first UE 302-1 can associate a first subset of its sidelink logical channels with a first sidelink resource scheduling mode, and associate a second subset of the sidelink logical channels with a second sidelink resource scheduling mode. In an embodiment, each of the sidelink logical channels is associated with a sidelink logical channel group. In an embodiment, the first sidelink resource scheduling mode is sidelink resource scheduling mode 1, while the second sidelink resource scheduling mode is sidelink resource scheduling mode 2. Accordingly, the base station 301 can assign a specific set of PSCCH/PSSCH resources to the first subset of the sidelink logical channels of the first UE 302-1 by means of a scheduling grant, and the first UE 302-1 by itself can select the PSCCH/PSSCH resources for the second subset of the sidelink logical channels autonomously.

At step S404, the first UE 302-1 determines whether a sidelink resource grant is associated with the first sidelink resource scheduling mode. In an embodiment, when the sidelink resource grant is associated with the first sidelink resource scheduling mode, the method 400 proceeds to step S406. In another embodiment, when the sidelink resource grant is associated with the second sidelink resource scheduling mode, the method 400 proceeds to step S408.

At step S406, the first UE 302-1 transmits data of the first subset of the sidelink logical channels that is associated with the first sidelink resource scheduling mode over the sidelink resource grant. For example, the sidelink resource grant is associated with the first sidelink resource scheduling mode, the first sidelink resource scheduling mode is sidelink resource scheduling mode 1, and the first UE 302-1 can transmit the data of the first subset of the sidelink logical channels, which are associated with sidelink resource scheduling mode 1, over the sidelink resource grant with sidelink resources allocated by the base station 301. Accordingly, the first UE 302-1 do not multiplex the data of the second subset of the sidelink logical channels, which are associated with sidelink resource scheduling mode 2, into the same MAC PDUs as the data of the first subset of the sidelink logical channels, as they may have different quality of service (QoS).

As mentioned above, the first UE 302-1 can send an SL SR to the base station 301 to ask the base station 301 to send an UL grant so that the first UE 302-1 can transmit PUSCH. For example, the first UE 302-1 can send the SL SR first, and then the base station 301 issues the UL grant. In an embodiment, the method 400 can further include transmitting a sidelink scheduling request (SL SR) to the base station.

In order for the base station 301 to allocate an exact set of sidelink resources to the first UE 302-1, the first UE 302-1 can send the SL BSR and report the amount of sidelink data in its sidelink transmitting buffer to the base station 301 before the base station 301 issues the sidelink scheduling resource grant. In an embodiment, the sidelink scheduling resource grant is associated with the first sidelink resource scheduling mode, the first sidelink resource scheduling mode is the sidelink resource scheduling mode 1, which indicates that the data of the first subset of the sidelink logical channels are transmitted over the sidelink resource grant with sidelink resources that are allocated by the base station 301, and the method 400 can further include transmitting an SL BSR to the base station 301.

At step S408, the first UE 302-1 can transmit data of the second subset of the sidelink logical channels that is associated with the second sidelink resource scheduling mode over the sidelink resource grant. For example, the sidelink resource grant is associated with the second sidelink resource scheduling mode, the second sidelink resource scheduling mode is sidelink resource scheduling mode 2, and the first UE 302-1 can transmit the data of the second subset of the sidelink logical channels, which are associated with the sidelink resource scheduling mode 2, over the sidelink resource grant with sidelink resources selected by the first UE 302-1. Accordingly, the first UE 302-1 do not multiplex the data of the first subset of the sidelink logical channels, which are associated with sidelink resource scheduling mode 1, into the same MAC PDUs as the data of the second subset of the sidelink logical channels, which may result in QoS degradation, as the data of the first subset of the sidelink logical channels, which are associated with sidelink resource scheduling mode 1, generally have higher QoS than the data of the second subset of the sidelink logical channels, which are associated with sidelink resource scheduling mode 2.

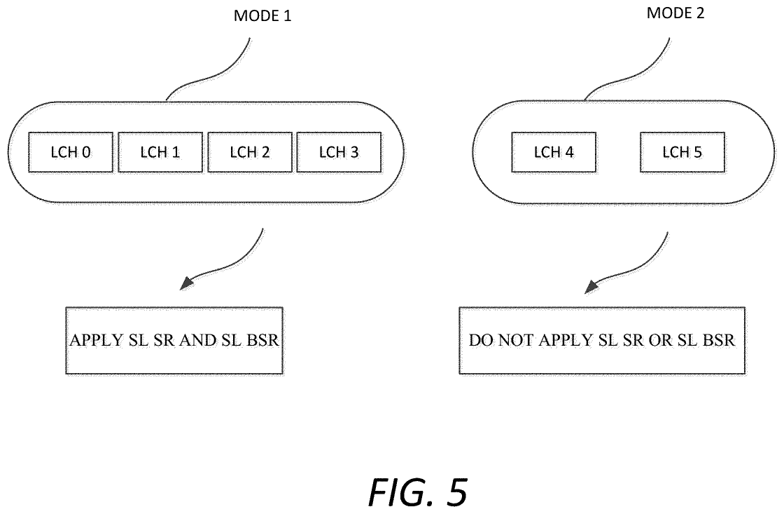

FIG. 5 shows an exemplary implementation of the method 400 for managing traffic prioritization among sidelink logical channels according to some embodiments of the disclosure. For example, the first UE 302-1 can have sidelink logical channels LCHs 0-5. In an embodiment, the first UE 302-1 can divide the sidelink logical channels LCHs 0-5 into two subsets, one of which includes the sidelink logical channels LCHs 0-3, and the other of which includes the sidelink logical channels LCHs 4 and 5. In another embodiment, the first UE 302-1 can associate the sidelink logical channels LCHs 0-3 with sidelink resource scheduling mode 1, and associate the sidelink logical channels LCHs 4 and 5 with sidelink resource scheduling mode 2. Therefore, only the sidelink logical channels LCHs 0-3 can apply the SL SR and SL BSR. Depending on which of the sidelink resource scheduling modes 1 and 2 that a sidelink resource grant is associated with, data of the first or second subset of the sidelink logical channels that are associated with the associated sidelink resource scheduling mode will be transmitted.

In an embodiment, the sidelink resource grant is associated with the sidelink resource scheduling mode 1, and the first UE 302-1 can transmit data of the sidelink logical channels LCHs 0-3, which are associated with the sidelink resource scheduling mode 1, over the sidelink resource grant with sidelink resources allocated by the base station 301. In another embodiment, the sidelink resource grant is associated with the sidelink resource scheduling mode 2, and the first UE 302-1 can transmit data of the sidelink logical channels LCHs 4 and 5, which are associated with the sidelink resource scheduling mode 2, over the sidelink resource grant with sidelink resources that the first UE 302-1 selects by itself autonomously.

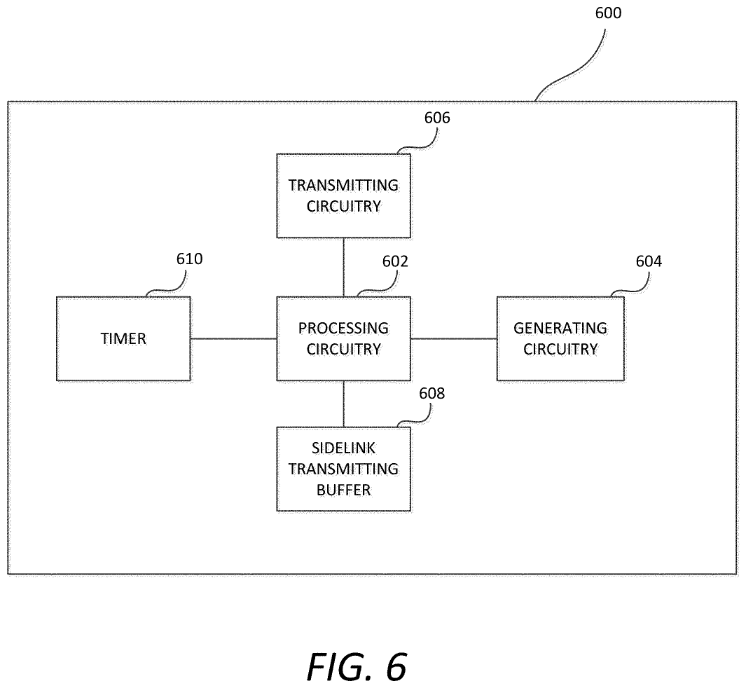

FIG. 6 is a block diagram of an apparatus 600 for managing sidelink traffic prioritization among sidelink logical channels according to some embodiments of the disclosure. The apparatus 600 can be configured to perform various functions in accordance with one or more embodiments or examples described herein. Thus, the apparatus 600 can provide means for implementation of mechanisms, techniques, processes, functions, components or systems described herein. For example, the apparatus 600 can be used to implement functions of UEs in various embodiments and examples described herein. The apparatus 600 can include a general purpose processor and/or specifically designed circuits to implement various functions, components or processes described herein in various embodiments. In an embodiment shown in FIG. 6, the apparatus 600 can include processing circuitry 602, generating circuitry 604, transmitting circuitry 606, a sidelink transmitting buffer 608 and a timer 610.

In an embodiment, the processing circuitry 602 can include circuitry configured to perform the functions and processes described herein in combination with software or without software. In various embodiments, the processing circuitry 602 can be a digital signal processor (DSP), an application specific integrated circuit (ASIC), a programmable logic device (PLD), a field programmable gate array (FPGA), a digitally enhanced circuit, a comparable device, or a combination thereof. In an embodiment, the processing circuitry 602 can associate sidelink logical channels with priorities and sidelink cast types. For example, the processing circuitry 602 can associate six sidelink logical channels 0-5 with priorities of 4, 0, 1, 2, 5 and 3, respectively, and with sidelink cast types of broadcast, groupcast, unicast, groupcast, unicast, and groupcast, respectively. In another embodiment, the processing circuitry 602 can further determine a first sidelink logical channel having a highest priority of the sidelink logical channels according to the priorities of the sidelink logical channels. For example, the processing circuitry 602 can determine the sidelink logical channel 1 to be the first sidelink logical channel.

The generating circuitry 604 can also include circuitry configured to perform the functions and processes described herein in combination with software or without software. In various embodiments, the generating circuitry 604 can also be a DSP, an ASIC, a PLD, an FPGA, a digitally enhanced circuit, a comparable device, or a combination thereof. In an embodiment, the generating circuitry 604 can generate a MAC PDU, wherein data of a subset of the sidelink logical channels that has a same sidelink cast type as the first sidelink logical channel are multiplexed into the MAC PDU. For example, the generating circuitry 604 can multiplex data of the sidelink logical channels 1, 3 and 5 into the MAC PDU, as the sidelink logical channel 1 has the highest priority and the sidelink logical channels 3 and 5 have the same sidelink cast type (i.e., the groupcast type) as the highest-priority sidelink logical channel 1. Therefore, the data in the MAC PDU have the same sidelink cast type, and contain the data of the sidelink logical channel having the highest priority.

In an embodiment, the processing circuitry 602 can be further configured to associate a first subset of the sidelink logical channels with a first sidelink resource scheduling mode, associate a second subset of the sidelink logical channels with a second sidelink resource scheduling mode, and determine a sidelink resource grant associated with the first sidelink resource scheduling mode or the second sidelink resource scheduling mode, and the transmitting circuitry 606 can be configured to transmit data of the first subset of the sidelink logical channels that is associated with the first sidelink resource scheduling mode over the sidelink resource grant when the sidelink resource grant is associated with the first sidelink resource scheduling mode, and transmit data of the second subset of the sidelink logical channels that is associated with the second sidelink resource scheduling mode over the sidelink resource grant when the sidelink resource grant is associated with the second sidelink resource scheduling mode.

In another embodiment, the sidelink resource grant can be associated with the first sidelink resource scheduling mode, the data of the first subset of the sidelink logical channels can be transmitted over the sidelink resource grant with sidelink resources that are allocated by a base station, and the transmitting circuitry 606 can be further configured to transmit a sidelink scheduling request to the base station. In some other embodiment, the sidelink transmitting buffer 608 can be configured to store sidelink data. In various embodiments, the processing circuitry 602 can be further configured to determine priorities of the sidelink data stored in the sidelink transmitting buffer 608 and data arrived at the sidelink transmitting buffer 608, and the transmitting circuitry 606 can transmit the sidelink scheduling request to the base station when the data arrived at the sidelink transmitting buffer 608 have a higher priority than the sidelink data stored in the sidelink transmitting buffer 608.

In an embodiment, the transmitting circuitry 606 can be further configured to transmit a sidelink buffer status report (BSR) to the base station. In another embodiment, the sidelink BSR can report an amount of the sidelink data stored in the sidelink transmitting buffer 608. In some other embodiments, the transmitting circuitry 606 can transmit the sidelink BSR to the base station when the sidelink transmitting buffer 608 is empty and sidelink data become available for transmission. In various embodiments, the transmitting circuitry 606 can transmit the sidelink BSR when sidelink data become available for transmission on a sidelink logical channel having a higher priority than those that the sidelink transmitting buffer 608 stores. In yet another embodiment, the transmitting circuitry 606 can transmit the sidelink BSR when the timer 610 expires while data are waiting for transmission.

When the first UE 302-1, after being allocated sidelink resources mode 1 by the base station 301 and selecting by itself sidelink resources mode 2, moves out of the coverage of the base station 301 (out-of-coverage), it cannot transmit data with the sidelink resources mode 1 any longer. In such an scenario, the first UE 302-1 may serve the traffic/LCH/LCG/radio bearer originally configured for the sidelink resources mode 1 with the sidelink resources mode 2, provide an indication to V2X higher layers that it is unable to serve some V2X services with the sidelink resources mode 1, provide an indication to V2X higher layers that it is unable to serve some V2X services with the sidelink resources mode 2 as it found that the sidelink resources mode 2 cannot support a high enough QoS due to a high channel busy ratio (CBR) or a high interference, or reconfigure the sidelink logical channels associated with the sidelink resource scheduling mode 1 to be associated with the sidelink resource scheduling mode 2 and select sidelink resources for the sidelink logical channels.

Afterward, when the first UE 302-1 moves back into the coverage of the base station 301 (in-coverage) again and is still in RRC-IDLE, it may enter RRC-CONNECTED to request the base station 301 to allocate sidelink resources if it has to serve high QoS stringent V2X services, or stay in RRC IDLE and select sidelink resources by itself, without entering RRC_CONNECTED. The first UE 302-1 may also decide whether to enter RRC_CONNECTED based on the characteristics/configurations of the running V2X services. For example, the network may provide some guidelines (e.g., admission control) on which kind/priority of V2X services can trigger the first UE 302-1 to enter RRC_CONNECTED. The first UE 302-1 may indicate the information of in-coverage to the V2X upper layers, letting the upper layers to decide if the current running V2X services need better QoS support, and, if so, instruct the first UE 302-1 to enter RRC_CONNECTED. Further, the first UE 302-1 may check whether the system information block (SIB) for V2X includes a resource pool, and stay in RRC_IDLE/RRC_INACTIVE if the SIB has included the resource pool; otherwise, the first UE 302-1 may enter RRC_CONNECTED to acquire the resource pool.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
associating sidelink logical channels with priorities and sidelink cast types at a user equipment (UE);
determining a first sidelink logical channel having a highest priority of the sidelink logical channels according to the priorities of the sidelink logical channels; and
generating a medium access control (MAC) protocol data unit (PDU), wherein data of a subset of the sidelink logical channels that has a same sidelink cast type as the first sidelink logical channel are multiplexed into the MAC PDU.

2. The method of claim 1, wherein the sidelink cast types include a unicast type, a groupcast type, and a broadcast type.

3. The method of claim 2, wherein the subset of the sidelink logic channels has the unicast type, and the data of the subset of the sidelink logic channels have a same destination ID.

4. The method of claim 2, wherein the subset of the sidelink logic channels has the groupcast type, and the data of the subset of the sidelink logic channels have a same destination group ID.

5. The method of claim 1, further comprising:
associating a first subset of the sidelink logical channels with a first sidelink resource scheduling mode and associating a second subset of the sidelink logical channels with a second sidelink resource scheduling mode;
determining a sidelink resource grant associated with the first sidelink resource scheduling mode or the second sidelink resource scheduling mode;
transmitting data of the first subset of the sidelink logical channels that is associated with the first sidelink resource scheduling mode over the sidelink resource grant when the sidelink resource grant is associated with the first sidelink resource scheduling mode; and
transmitting data of the second subset of the sidelink logical channels that is associated with the second sidelink resource scheduling mode over the sidelink resource grant when the sidelink resource grant is associated with the second sidelink resource scheduling mode.

6. An apparatus, comprising:
processing circuitry configured to associate sidelink logical channels with priorities and sidelink cast types at a UE, and determine a first sidelink logical channel having a highest priority of the sidelink logical channels according to the priorities of the sidelink logical channels; and
generating circuitry configured to generate a medium access control (MAC) protocol data unit (PDU), wherein data of a subset of the sidelink logical channels that has a same sidelink cast type as the first sidelink logical channel are multiplexed into the MAC PDU.

7. The apparatus of claim 6, further comprising transmitting circuitry, wherein the processing circuitry is further configured to associate a first subset of the sidelink logical channels with a first sidelink resource scheduling mode, associate a second subset of the sidelink logical channels with a second sidelink resource scheduling mode, and determine a sidelink resource grant associated with the first sidelink resource scheduling mode or the second sidelink resource scheduling mode, and the transmitting circuitry is configured to transmit data of the first subset of the sidelink logical channels that is associated with the first sidelink resource scheduling mode over the sidelink resource grant when the sidelink resource grant is associated with the first sidelink resource scheduling mode, and transmit data of the second subset of the sidelink logical channels that is associated with the second sidelink resource scheduling mode over the sidelink resource grant when the sidelink resource grant is associated with the second sidelink resource scheduling mode.

8. The apparatus of claim 7, wherein the sidelink resource grant is associated with the first sidelink resource scheduling mode, the data of the first subset of the sidelink logical channels are transmitted over the sidelink resource grant with sidelink resources that are allocated by a base station, and the transmitting circuitry is further configured to transmit a scheduling request to the base station.

9. The apparatus of claim 8, further comprising a sidelink transmitting buffer configured to store sidelink data, wherein the processing circuitry is further configured to determine priorities of the sidelink data stored in the sidelink transmitting buffer and data arrived at the sidelink transmitting buffer, and the transmitting circuitry is further configured to transmit the scheduling request to the base station when the data arrived at the sidelink transmitting buffer have a higher priority than the sidelink data stored in the sidelink transmitting buffer.

10. The apparatus of claim 9, wherein the transmitting circuitry is further configured to transmit a sidelink buffer status report (BSR) to the base station.

11. The apparatus of claim 10, wherein the transmitting circuitry is further configured to transmit the sidelink BSR to the base station when for a specific destination UE, the sidelink transmitting buffer is empty and data for the destination UE become available for transmission.

12. The apparatus of claim 10, wherein the transmitting circuitry is further configured to transmit the sidelink BSR when for a destination UE, data become available for transmission on a logical channel having a higher priority than those that the sidelink transmitting buffer stores for the destination UE.

13. The apparatus of claim 10, further comprising a timer, wherein the transmitting circuitry is further configured to transmit the sidelink BSR when the timer expires while data are waiting for transmission.

14. The apparatus of claim 7, wherein the sidelink resource grant is associated with the second sidelink resource scheduling mode, the data of the second subset of the sidelink logical channels are transmitted over the sidelink resource grant with sidelink resources that are selected by the UE.

15. The apparatus of claim 6, wherein the processing circuitry associates each of the sidelink logical channels with a sidelink logical channel group.

16. A method, comprising:
associating a first subset of sidelink logical channels with a first sidelink resource scheduling mode and associating a second subset of the sidelink logical channels with a second sidelink resource scheduling mode;
determining a sidelink resource grant associated with the first sidelink resource scheduling mode or the second sidelink resource scheduling mode;
transmitting data of the first subset of the sidelink logical channels that is associated with the first sidelink resource scheduling mode over the sidelink resource grant when the sidelink resource grant is associated with the first sidelink resource scheduling mode; and
transmitting data of the second subset of the sidelink logical channels that is associated with the second sidelink resource scheduling mode over the sidelink resource grant when the sidelink resource grant is associated with the second sidelink resource scheduling mode.

17. The method of claim 16, wherein the sidelink resource grant is associated with the first sidelink resource scheduling mode, the data of the first subset of the sidelink logical channels are transmitted over the sidelink resource grant with sidelink resources that are allocated by a base station, and the method further comprises transmitting a scheduling request to the base station.

18. The method of claim 17, further comprising transmitting a sidelink buffer status report to the base station.

19. The method of claim 16, wherein each of the sidelink logical channels is associated with a sidelink logical channel group.

20. The method of claim 16, further comprising:
associating the sidelink logical channels with priorities and sidelink cast types at a UE;
determining a first sidelink logical channel having a highest priority of the sidelink logical channels according to the priorities of the sidelink logical channels; and
generating a MAC PDU, wherein data of a subset of the sidelink logical channels that has a same sidelink cast type as the first sidelink logical channel are multiplexed into the MAC PDU.
